(19) United States
(12) Patent Application Publication
(10) Pub. No.: US 2006/0140233 A1
(43) Pub. Date: Jun. 29, 2006

(54) Laser driver with integrated bond options for selectable currents

(76) Inventors: Jesse Chin, Saratoga, CA (US); An-Chun Tien, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/024,504

(22) Filed: Dec. 28, 2004

(51) Int. Cl. H01S 3/00

(52) U.S. Cl. 372/38.02; 372/38.05; 372/38.07

(57) ABSTRACT

A programmable laser driver may be programmed to meet the characteristics of a particular laser. Traditionally, external resistors are used to bias the driver and program the value of the drive current to suit a particular laser. Embodiments of the present invention comprise integrating a plurality of resistors with the IC driver and providing a bonding bad for each resistor. Thus, different drive currents may be selectable based on different bonding patterns corresponding to different bias resistance selections. These bond options allow the selection of different ranges of bias current, modulation current and temperature coefficients necessary to drive various lasers.

### FIELD OF THE INVENTION

Embodiments of the present invention relate to lasers and, more particularly to laser drivers.

### BACKGROUND INFORMATION

Lasers are used in a wide variety of applications. In particular, lasers are integral components in optical communication systems where a beam modulated with vast amounts of information may be communicated great distances at the speed of light over optical fibers as well as short reach distances such as from chip-to-chip in a computing environment.

Many lasers are commercially available from a variety of vendors that use off-chip resistors to control bias and modulation currents supplied by the laser driver. While resistors may be inexpensive devices for controlling driver current they do not allow for flexibility or adjustments. In order to vary the drive current, a different resistor should be installed. For that reason, variable resistors (potentiometers) or digital-to-analog current sources (DACS) have also been used to provide more flexibility and to allow for current adjustments to be made to tune a driver for a particular laser's specifications.

While external resistors or variable resistors are widely used to tune laser drivers, they are external to the driver chip and therefore not part of the integrated circuit (IC). Further, they involve manual tuning for each different laser. The DACS approach, on the other hand, may be integrated on the IC chip, but typically requires more complicated circuitry and extra pins in the transceiver package for a serial interface to program the currents for the IC.

### BRIEF DESCRIPTION OF THE DRAWINGS

FIG. 1 is a block diagram of an optical transceiver package;

FIG. 2 is a block diagram of an integrated circuit (IC) laser driver using external programable resistors for tuning;

FIG. 3 is a block diagram of an IC laser driver having integrated resistance bias options selectable by choosing different bonding pads;

FIG. 4 is a block diagram of an IC laser driver showing one example of bonding options;

FIG. 5 is a block diagram of an IC laser driver showing another example of bonding options; and

FIG. 6 is an exemplary system utilizing embodiments of the IC laser driver.

### DETAILED DESCRIPTION

The embodiments relate to a laser driver circuit having selectable currents based on different bonding patterns. It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Numerous specific details may be set forth herein to provide a thorough understanding of the embodiments. It will be understood by those skilled in the art, however, that the embodiments may be practiced without these specific details. In other instances, well-known methods, procedures, components and circuits have not been described in detail so as not to obscure the embodiments. It can be appreciated that the specific structural and functional details disclosed herein may be representative and do not necessarily limit the scope of the embodiment.

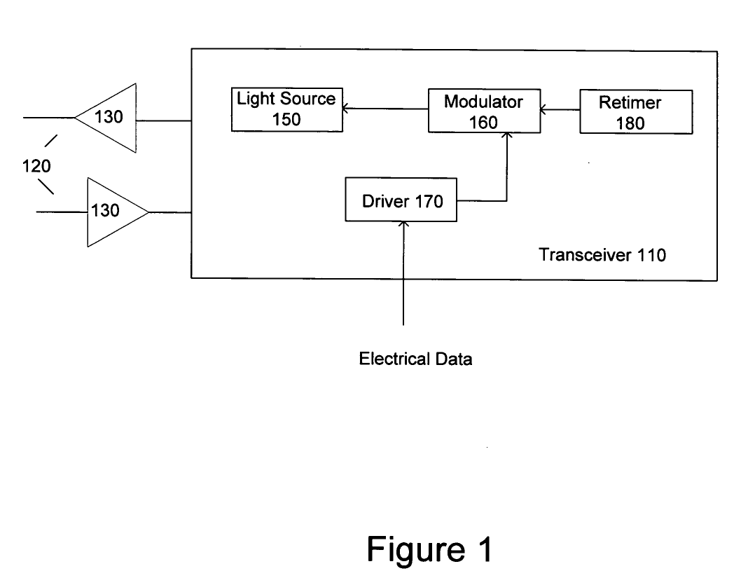

Referring now in detail to the drawings wherein like parts are designated by like reference numerals throughout, FIG. 1 is a block diagram of transceiver 110 utilized in high speed optical communication systems suitable for practicing one embodiment. Transceiver module 110 is operatively responsive to transmission medium 120 configured to allow the propagation of a plurality of information signals. The expression “information signals,” as used herein, refers to an optical or electrical signal which has been coded with information. An optical communication is configured with transceivers at both ends of transmission medium 120 to accommodate bidirectional communication within a single line card. Additional amplifiers 130 may also be disposed along transmission medium 120 depending on the desired transmission distances and associated span losses in order to provide an information signal having a power level sufficient for detection and processing by the receive functionality (not shown) of transceiver 110.

The information signals transmitted by transceiver 110 may be modulated using various techniques including return to zero (RZ) where the signal returns to a logic 0 before the next successive date bit and/or non-return to zero (NRZ) format where the signal does not return to a logic 0 before the next successive data bit. Transceiver 110 may comprise a light source 150, such as a semiconductor laser, modulator 160, driver 170 and re-timer circuit or encoder circuit 180 to transmit optical signals. Re-timer circuit 180 may be present and receives information signals in electrical form and supplies these signals to modulator 160 which provides current variations proportional to the received information signals to modulator 160. Light source 150, such as a laser, generates optical signals proportional to the received current levels for propagation over transmission medium 120.

Light source 150 may be directly modulated obviating the need for modulator 160. In a directly modulated laser (DML) configuration, a minimum current signal, also known as a threshold current, is applied to the laser causing the laser to operate in the lasing mode. This threshold current is temperature dependant and may vary over the operating range of the laser. In order to modulate the laser, the current signal is varied between a point near the threshold current corresponding to an “off” state and above the threshold current to correspond to an “on” state consistent with the data to be modulated. This technique is used so that the laser remains in the lasing mode which avoids going from a true off state, below the lasing threshold, to the lasing threshold.

In high gigabit data transmission, however, it may be more difficult to switch the laser between these two levels. Therefore, external modulation may be more desirable. In external modulation, the driver 170 may directly drive the laser 150 to remain in a constant lasing mode and the data is modulated externally.

In one embodiment, there are two types of external modulators, namely a lithium niobate (LiNbO3) Mach-Zender interferometer and an electro-absorption (EA) modulator. EA modulators make use of either Pockels effect or the quantum confinement Stark effect of a quantum well where the refractive index of the semiconductor material is changed upon application of an applied voltage. EA modulators are fabricated on a single chip with a distributed feedback (DFB) laser and may be driven at relatively low voltage levels. Similarly, in a Mach-Zender modulator an RF signal changes the refractive index around a pair of waveguides. The modulator has two waveguides and the incoming light is supplied to each waveguide where a voltage may be applied to one or both of the waveguides. This electric field changes the refractive index so that the light emerging from one waveguide will be out of phase with the light output from the other waveguide. When the light is recombined, it interferes destructively, effectively switching the light off. Without an applied field the light is in phase and remains “on” thereby producing a corresponding modulated signal.

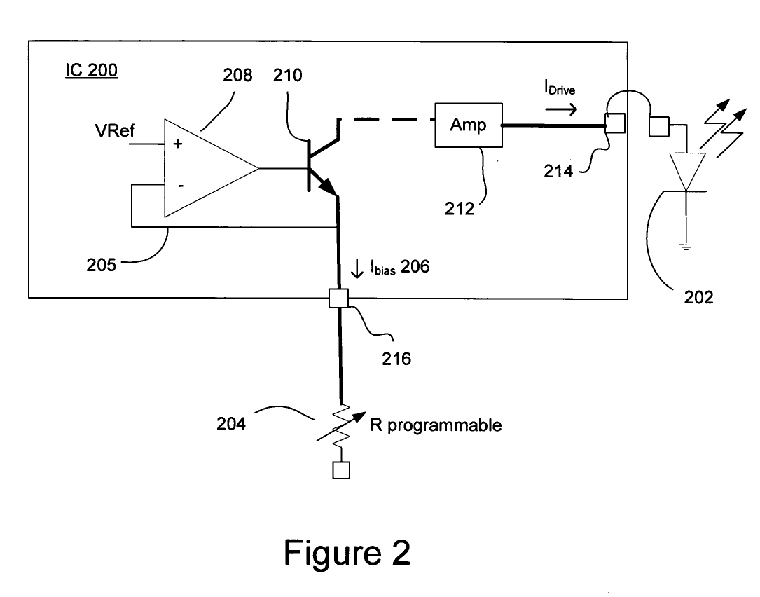

FIG. 2 is a diagram of a laser driver on an integrated circuit (IC) 200 directly driving a laser 202. The driver 200 translates an output programmable resistance 204 into a programmable current (I_{bias}) 206. The simplified internal circuitry as shown may include an operational amplifier 208 provided with a reference voltage V_{ref}. The output of the operational amplifier 208 connects to a transistor 210 causing the transistor to conduct the programmable current (I_{bias}) 206. The voltage at pin 216 may be fed back 205 to the operational amplifier 208. The transistor 210 shown is a bipolar transistor, however embodiments may include other technology families such as, for example, CMOS or BiCMOS circuitry. The programmable current (I_{bias}) 206 flowing through the transistor 210 may be amplified via a current amplifier 212, the output of which is routed to an output pin 214 and comprises the output of the laser driver 200 to drive the laser 202.

A resistor 204 connected between ground and an I_{Bias} control pin 216 may provide a consistent control current for the driver 200. Changing the value of the resistor 204, whether by substituting a resistor of a different value or by varying the value of a variable resistor will effect a corresponding change in the value of the bias current (I_{bias}) 206 and thus a corresponding change in the drive current I_{drive}. It may be worthwhile to note that the laser driver 200 responds to the amount of current pulled out of I_{Bias} control pin, not the value of the resistor 204 connected to it. Thus, the resistor may be replaced by a DAC or other external programmable current source. Typically, the gain of the current amplifier 212 is on the order of 100-200 (mA/mA), and typical output currents are up to 50-80 mA.

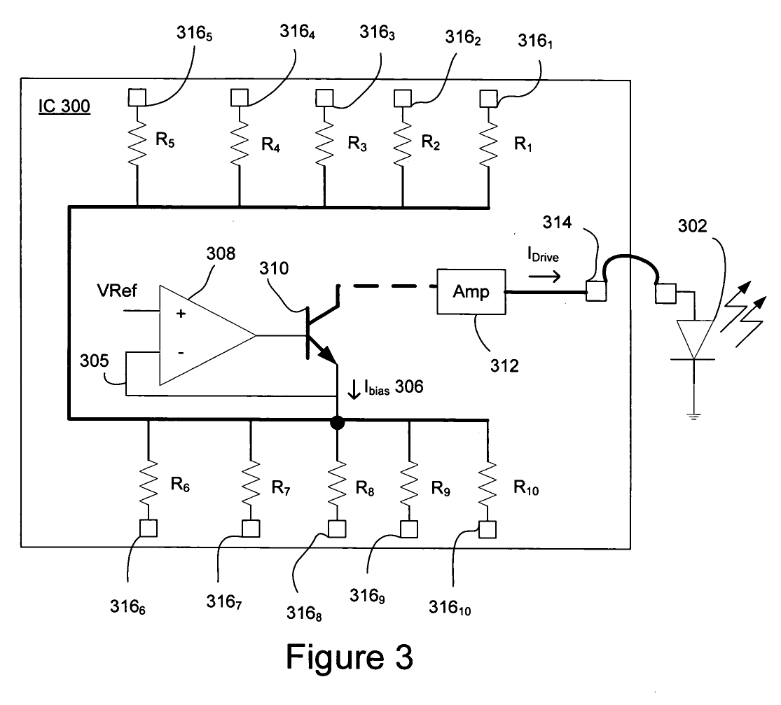

FIG. 3 shows an embodiment of the laser driver which eliminates the use of an external resistor or other external programmable current source. As before, the driver 300 may be integrated on an IC. A reference voltage V_{Ref} (for example 1.2V), may be used at the non-inverting input of an operational amplifier 308. The output of the operational amplifier 308 may be used to cause the current control transistor 310 to begin conducting a bias current I_{Bias}. The voltage at the output of the transistor 310 may be fed back 305 to the inverting input of the operational amplifier 308.

The transistor 310 shown is a bipolar transistor, however embodiments may include other technology families such as, for example, CMOS or BiCMOS circuitry. The bias current I_{Bias} 306 flowing through the transistor 310 may be amplified via a current amplifier 312, the output of which is routed to an output pin 314 and comprises the output of the laser driver 300 to drive the laser 302.

Rather than using an external resistor to program the value of the bias current I_{Bias} 306, embodiments of the present invention comprise a plurality of resistors R₁-R₁₀, integrated with the IC driver 300, each with its own bonding bad 316₁-316₁₀. While ten resistors and pads 316 are shown, this is by way of example only as more or less may be present in different embodiments. The values of each of the resistors R₁-R₁₀ may each comprise a different value. For example, in one embodiment they may range from 1Ω to 100Ω. Thus, different currents may be selectable based on different bonding patterns corresponding to different bias resistance selections. These bond options allow the selection of different ranges of bias current to suit the modulation current, temperature coefficients, etc. to drive various lasers 302.

Thus, according to embodiments, the IC driver 300 comprises a current source electively connectable with various loads (R₁-R₁₀). Each load (R₁-R₁₀) may be routed to its own bond pad 316. When left unbonded, these loads are high-impedance and do not affect the selected current I_{Bias} 306. The desired current is selected when a specific pad or combination of pads 316 is bonded to a supply (e.g. Vcc). If more than one pad 316 is bonded to a supply, different bias may be achieved since the values of the selected resistors R₁-R₁₀ will be added in parallel. For lasers with different characteristics, a single IC can be used by bonding the necessary resistor(s) (R₁-R₁₀) or current source networks of the IC driver 300.

In other embodiments, should the laser be connected to a supply voltage such as VCC, as may sometimes be the case, then the bonding pads may be selected by connecting them to ground rather than to a supply voltage.

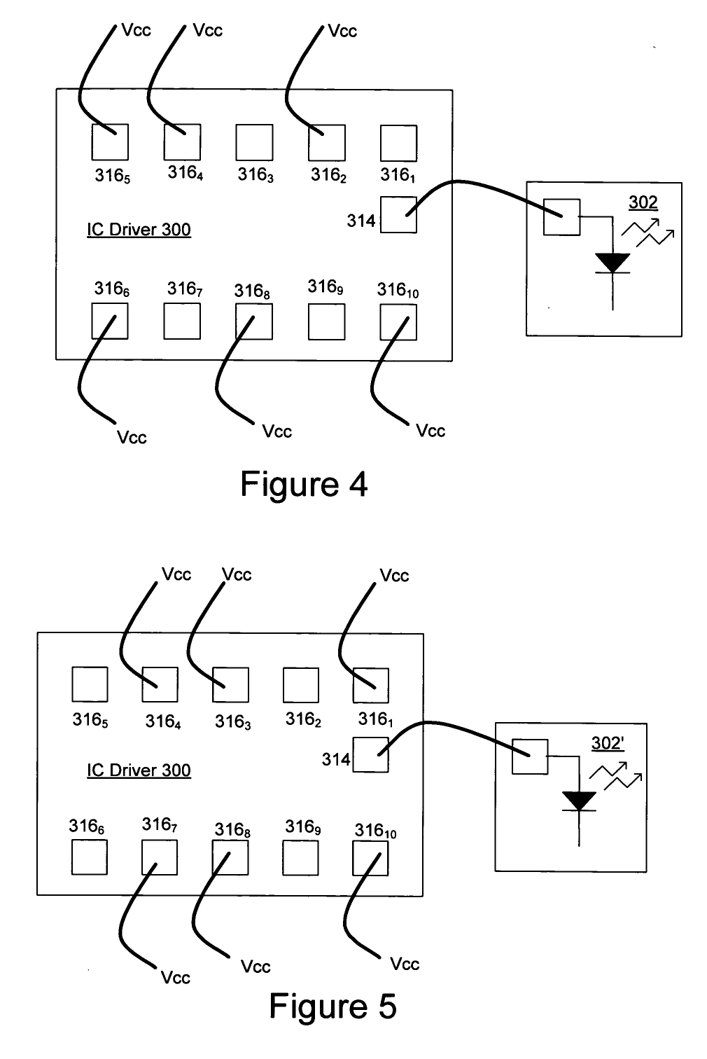

FIGS. 4 and 5 show various bonding options for different lasers 302 and 302′, respectively. Like items are labeled with like reference numerals from previous figures to avoid repetition. As shown in FIG. 4, the driver 300 may be customized to suit a particular laser's 302 specifications or characteristics simply by selecting the appropriate bonding options. For example, for laser 302, perhaps a bias resistance of say 23Ω is called for to achieve the desired drive current I_{drive}. In that case, bond pads 316₂, 316₄, 316₅, 316₆, 316₈, and 316₁₀ may be connected, such as by wire bonding 400 or flip-chip techniques, to a supply voltage such as VCC, since this resistance combination may produce a 23Ω bias resistance.

In another example, as shown in FIG. 5, the specifications for laser 302′ may call for a different bias resistance bonding combination to produce, for example a 50Ω bias resistance. Here, perhaps bonding pads 316₁, 316₃, 316₄, 316₇, 316₈, and 316₁₀, to a supply voltage may create the desired bias resistance. Of course the numerical resistance examples are offered for illustrative purposes only, and in practice, these resistance values may vary depending on the application.

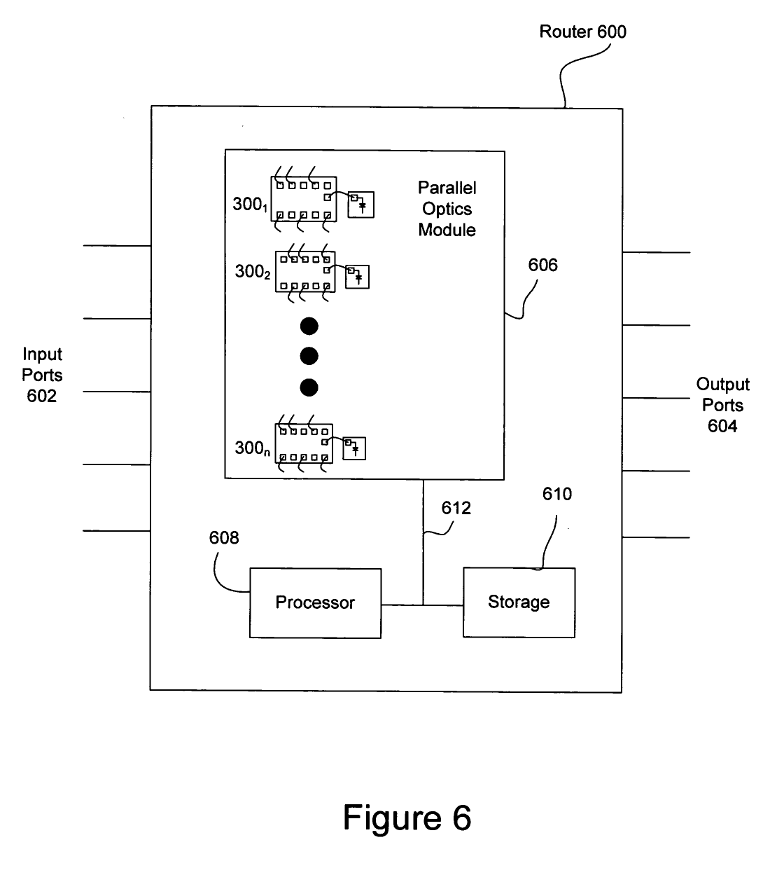

FIG. 6 illustrates an embodiment of a system, such as a router 600, that may use embodiments of the invention. Router 600 includes a parallel optics module 606 that may comprise a plurality of lasers and laser drivers 300₁-300ₙ. In another embodiment, router 600 may be a switch, or other similar network element. In an alternative embodiment, parallel optics module 606 may be used in a computer system, such as a server.

Parallel optics module 606 may be coupled to a processor 608 and storage 610 via a bus 612. In one embodiment, storage 610 has stored instructions executable by processor 608 to operate router 600.

Router 600 includes input ports 602 and output ports 604. In one embodiment, router 600 receives optical signals at input ports 602. The optical signals are converted to electrical signals by parallel optics module 606. Parallel optics module 606 may also convert electrical signals to optical signals and then the optical signals are sent from router 600 via output ports 604. According to embodiments of the invention, a similar driver 300 may be used for each individual laser, the difference being that different bonding options are selected for the driver to accommodate the specifications of the particular laser it is driving.

Embodiments allow a single IC driver to adapt to different laser thresholds and slope efficiencies. Whereas current laser driver ICs use one or more external resistors to accommodate different bias, modulation and temperature coefficient characteristics of a laser, present embodiments integrate these capabilities into a single IC. By reducing or eliminating external components embodiments allow for a reduced footprint transceiver package as well as reduces the package pin count by eliminating the use of a serial control interface to set the currents.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description.

The terms used in the following claims should not be construed to limit the invention to the specific embodiments disclosed in the specification. Rather, the following claims are to be construed in accordance with established doctrines of claim interpretation.

What is claimed is:

1. An integrated circuit, comprising:
a current source to drive a laser;
a plurality of resistors to bias the current source;
a plurality of pads associated with each of the plurality of resistors, wherein selecting one or more of the pads for bonding selects a desired bias resistance value.

2. The integrated circuit as recited in claim 1, wherein the current source comprises:
a transistor to conduct a bias current;
a current amplifier to provide a drive current proportional to the bias current.

3. The integrated circuit as recited in claim 2, further comprising:
an operational amplifier to switch on the transistor in response to a reference voltage.

4. The integrated circuit as recited in claim 2, wherein the transistor comprises one of a Bipolar transistor, CMOS transistor, and BiCMOS transistor.

5. The integrated circuit as recited in claim 1 wherein the selected pads are wire bonded.

6. The integrated circuit as recited in claim 1, wherein the pads are flip-chip solder bonded.

7. The integrated circuit as recited in claim 1, further comprising:
a plurality of the integrated circuits each to drive a particular laser,
the pads of each of the integrated circuits being bonded to according to the characteristics of the particular laser.

8. A method, comprising:
integrating a current source in an integrated circuit (IC);
integrating a plurality of bias resistors in the IC to program the current source;
providing a plurality of bond pads, one for each of the bias resistors;
connecting a laser to the current source; and
bonding one or more of the bond pads selected according to drive characteristics of the laser.

9. The method according to claim 8 wherein the characteristics of the laser comprise modulation and temperature coefficient characteristics.

10. The method according to claim 8 wherein the bonding comprises wire bonding to one of a supply and ground;

11. The method according to claim 8 wherein the bonding comprises flip chip bonding to one of a supply and ground.

12. The method according to claim 8, further comprising:
arranging the plurality of bias resistors in parallel to bias a transistor comprising the current source.

13. The method according to claim 12, further comprising:
amplifying a current flowing through the transistor to provide a drive current for the laser.

14. A system, comprising:
a parallel optics module including a plurality of programmable laser drivers, each driving a particular laser, each of the laser drivers comprising:
a current source to drive the particular laser;
a plurality of resistors to bias the current source;
a plurality of pads associated with each of the plurality of resistors,
wherein selecting one or more of the pads for bonding selects a desired bias resistance value selected according to characteristics of the particular laser;
input and output ports for transporting data signals through the parallel optics module;
a processor for controlling the parallel optics module; and
a memory connected to the processor.

15. The system as recited in claim 14 wherein the system comprises a router.

16. The system as recited in claim 14 wherein each of the programmable laser drivers is formed on an integrated circuit (IC) chip.

17. The system as recited in claim 16 wherein all resistors to bias the current source are contained within the IC.

18. The system as recited in claim 16 wherein bonding comprises wire bonding to one of a supply and ground.

19. The system as recited in claim 16 wherein the bonding comprises flip chip bonding to one of a supply and ground.

20. The system as recited in claim 16 wherein the characteristics of the particular laser comprise modulation and temperature coefficient characteristics.
